(19) United States
(12) Patent Application Publication
(10) Pub. No.: US 2009/0300972 A1
(43) Pub. Date: Dec. 10, 2009

(54) Physical Refining Process Using Adsorbent Particles for the Production of Biodiesel Fuel

(76) Inventors: Massoud Jalalpoor, Schifferstadt (DE); Ian Page, Karlsruhe (DE)

Correspondence Address: William D. Bunch;W R Grace & Co.-Conn,, Patent Department, Legal Service Group, 7500 Grace Drive, Columbia, MD, 21044, US

(21) Appl. No.: 12/224,528

(22) PCT Filed: Feb. 27, 2007
(86) PCT No.: PCT/EP2007/001688

§ 371 Date: Apr. 27, 2009

Related U.S. Application Data
(60) Provisional application No. 60/777,303, filed on Feb. 28, 2006.

(51) Int. Cl. C10L 1/18; C11B 7/00; B01D 11/00

(52) U.S. Cl. 44/308; 554/193; 422/261

(57) ABSTRACT

Physical refining processes using adsorbent particles are disclosed. The physical refining processes may be used in the production of biodiesel fuel precursors and biodiesel fuel.

### FIELD OF THE INVENTION

The present invention is directed to a physical refining process and system for making a biodiesel fuel precursor, which can be further processed to make a biodiesel fuel.

### BACKGROUND OF THE INVENTION

There is a need in the art for methods of efficiently and effectively removing phospholipids, associated trace elements and free fatty acids from degummed triglycerides in a cost-effective manner. Further, there is a need in the art for methods of making biodiesel fuel in a cost-effective manner.

### SUMMARY OF THE INVENTION

The present invention relates to the discovery of methods of making a biodiesel fuel precursor and biodiesel fuel. The disclosed methods of the present invention remove phospholipids, associated trace elements such as Ca, Mg and Fe, and free fatty acids from degummed triglycerides in a cost-effective manner resulting in a biodiesel fuel precursor that can be further processed to form a biodiesel fuel. The disclosed methods are suitable for forming a biodiesel fuel precursor without the generation of water effluent and without the need for relatively complex equipment and relatively high-cost, time-consuming process steps, such as a deodorizing step.

The present invention is directed to methods of making biodiesel fuel precursor. In one exemplary embodiment, the method of making a biodiesel fuel precursor comprises the steps of bringing degummed triglycerides into contact with a plurality of adsorbent particles to reduce an amount of phosphorus within the degummed triglycerides so as to form phospholipids-deficient triglycerides having from greater than about 2 ppm to about 10 ppm phosphorus; and converting the phospholipids-deficient triglycerides into a biodiesel fuel precursor. Conversion of the phospholipids-deficient triglycerides into a biodiesel fuel may comprise one or more process steps including a transesterification step.

In another exemplary embodiment, the method of making a biodiesel fuel precursor comprises the step of contacting phospholipids-deficient triglycerides with a stripping medium to reduce an amount of free fatty acids within the phospholipids-deficient triglycerides to an amount ranging from greater than 0.04 wt % to about 0.20 wt % based on a total weight of the phospholipids-deficient triglycerides, wherein the contacting step produces a biodiesel fuel precursor.

In yet a further exemplary embodiment, the method of making a biodiesel fuel precursor comprises the steps of bringing degummed triglycerides into contact with a plurality of adsorbent particles to reduce an amount of phosphorus within the degummed triglycerides so as to form phospholipids-deficient triglycerides having from greater than about 1 ppm to about 10 ppm phosphorus; separating the phospholipids-deficient triglycerides from the plurality of adsorbent particles to form a adsorbent-free triglyceride product; and contacting the adsorbent-free triglyceride product with a stripping medium to reduce an amount of free fatty acids within the adsorbent-free triglyceride product so as to form a biodiesel fuel precursor having less than about 0.20 wt % free fatty acids based on a total weight of the biodiesel fuel precursor. In any of the above-mentioned methods of making a biodiesel fuel precursor, the method may further comprise the step of converting the biodiesel fuel precursor into a biodiesel fuel using a transesterification step.

The present invention is also directed to methods of making biodiesel fuel. In one exemplary embodiment, the method of making a biodiesel fuel comprises the steps of bringing degummed triglycerides into contact with a plurality of adsorbent particles to reduce an amount of phosphorus within the degummed triglycerides so as to form phospholipids-deficient triglycerides; separating the phospholipids-deficient triglycerides from the plurality of adsorbent particles to form a adsorbent-treated triglyceride product; contacting the adsorbent-treated triglyceride product with a stripping medium to reduce an amount of free fatty acids within the adsorbent-treated triglyceride product so as to form a biodiesel fuel precursor; reacting the biodiesel fuel precursor with one or more alcohols to form alkyl esters in combination with glycerin; and removing the glycerin from the alkyl esters to form a biodiesel fuel.

The present invention is even further directed to an apparatus capable of being used to make a biodiesel fuel precursor and/or a biodiesel fuel. In one exemplary embodiment, the apparatus suitable for making a biodiesel fuel comprises a mixing vessel suitable for bringing degummed triglycerides into contact with a plurality of adsorbent particles to reduce an amount of phospholipids within the degummed triglycerides so as to form phospholipids-deficient triglycerides; a filtration device in-line with the mixing vessel, the filtration device being suitable for separating the phospholipids-deficient triglycerides from the plurality of adsorbent particles so as to form a adsorbent-free triglyceride product; and a packed column in-line with the filtration device, the packed column being suitable for contacting the adsorbent-treated triglyceride product with a stripping medium to reduce an amount of free fatty acids within the adsorbent-treated triglyceride product so as to form a biodiesel fuel precursor. The apparatus may further include a reaction vessel in-line with the packed column, the reaction vessel being suitable for reacting the biodiesel fuel precursor with one or more alcohols to form alkyl esters in combination with glycerin; and a separation unit in-line with the reaction vessel, the separation unit being suitable for removing the glycerin from the alkyl esters to form a biodiesel fuel.

The present invention is directed to biodiesel fuel precursors produced by the methods of the present invention. The biodiesel fuel precursors may be further processed to produce biodiesel fuel without concerns such as the color or odor of the biodiesel fuel precursor and/or the biodiesel fuel. The resulting biodiesel fuel may be used in a combustion engine in place of other conventional fuels such as diesel fuel.

These and other features and advantages of the present invention will become apparent after a review of the following detailed description of the disclosed embodiments and the appended claims.

### BRIEF DESCRIPTION OF THE FIGURES

FIGS. 1A-1C depict a flow diagram of an exemplary method of making a biodiesel fuel precursor or biodiesel fuel of the present invention; and

FIG. 2 depicts a schematic diagram of an exemplary apparatus suitable for making a biodiesel fuel precursor or biodiesel fuel of the present invention.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

The present invention is directed to methods of making biodiesel fuel precursors. The present invention is further directed to methods of making and biodiesel fuel, as well as the biodiesel fuel produced. The present invention is even further directed to an apparatus capable of making biodiesel fuel precursors and biodiesel fuel. A description of exemplary methods of making biodiesel fuel precursors and biodiesel fuel is provided below.

### I. Methods of Making Biodiesel Fuel Precursors

The present invention is directed to methods of making a biodiesel fuel precursor. The methods of making a biodiesel fuel precursor containing a number of process steps, some of which are described below.

A. Steps for Making Biodiesel Fuel Precursors

The following steps may be used to make biodiesel fuel precursors of the present invention.

1. Degumming Step

Prior to being processed using the method of the present invention, crude triglycerides are subjected to a degumming step in which “gums” (e.g., referred to herein as phospholipids and phosphatides) are removed from the triglycerides. In a typical degumming step, triglycerides are subjected to a controlled reaction suitable for removing gums (e.g., phospholipids and/or phosphatides) from the triglycerides so as to obtain degummed triglycerides having less than about 70 ppm of phosphorus, and typically less than 50 ppm of phosphorus. Any conventional degumming step may be used to prepare degummed triglycerides for use in the methods of the present invention.

Suitable conventional degumming steps include, but are not limited to, an acid degumming step (e.g., the addition of an acid, such as phosphoric acid, citric acid or other acids, and water to crude or water degummed triglycerides, and subsequent centrifugation to reduce the amount of phosphatides in the triglycerides); a partial neutralization degumming step (e.g., the addition of an acid, such as phosphoric acid, citric acid or other acids, and to crude or water degummed triglycerides, partially neutralization of the mixture, and subsequent centrifugation to reduce the amount of phosphatides in the triglycerides); an enzymatic degumming step (e.g., the addition of an acid and water to crude or water degummed triglycerides, followed by a cooling/NaOH/enzyme addition/mixing step, and then a subsequent heating/centrifugation to reduce the amount of phosphatides in the triglycerides); and a dry enzymatic degumming step (e.g., the addition of an acid and a small amount of water to crude or water degummed triglycerides, followed by a cooling/NaOH/enzyme addition/mixing step.

Degumming processes are described in U.S. Pat. Nos. 4,049,686; 4,588,745; 4,609,500; 4,629,588; 4,698,185; 4,927,544; 5,008,047; 5,069,829; 5,079,208; 5,239,096; 5,298,638; 5,626,756; 5,696,278; 6,111,120; 6,346,286, and 6,797,172, the entire subject matter of which is incorporated herein by reference.

The degummed triglycerides produced from any of the above-mentioned degumming steps may be further processed using the method steps of the present invention as described below. Typically, the degummed triglycerides produced from any of the above-mentioned degumming steps contain below 70 ppm phosphorus, and more typically, less than 50 ppm of phosphorus, which is further lowered using the process steps described below.

2. Adsorbent Treatment Step

In the methods of the present invention, degummed triglycerides are brought into contact with adsorbent particles in order to remove phospholipids and other trace elements to a desired level. Typically, the adsorbent treatment step reduces the amount of phosphorus in the degummed triglycerides to less than about 10 ppm, typically, in a range of from about greater than 1 ppm to about 10 ppm, and more typically, greater than about 2 ppm (or about 3, or about 4, or about 5, or about 6 ppm) to about 10 ppm.

In this step of the present invention, any commercially available adsorbent particles may be used for contacting the degummed triglycerides, including natural or synthetic adsorbents comprising organic (e.g., natural and synthetic polymers, etc.) and/or inorganic materials (e.g. inorganic oxides such as clay, silica, alumina, etc.). Examples include natural minerals, processed/activated minerals, montmorillonite, attapulgite, bentonite, palygorskite, Fuller's earth, diatomite, smectite, hormite, quartz sand, limestone, kaolin, ball clay, talc, pyrophyllite, perlite, sodium silicate, sodium aluminum silicate, magnesium silicate, magnesium aluminum silicate, silica hydrogel, silica gel, colloidal silica, fumed silica, precipitated silica, dialytic silica, fibrous materials, cellulose, cellulose esters, cellulose ethers, microcrystalline cellulose; alumina zeolite, starches, molecular sieves, diatomaceous earth, ion exchange resin, size exclusion chromatography resin, chelating resins, rice hull ash, reverse phase silica, bleaching Clay, and all types of activated carbons, and mixtures thereof. Commercially available silica particles include, but are not limited to, TriSyl® silica hydrogel particles commercially available from W.R. Grace (Columbia, Md.). A description of TriSyl® silica hydrogel particles may be found in U.S. Pat. Nos. 5,336,794, 5,231,201, 4,939,115, 4,734,226, and 4,629,588, the subject matter of each of which is hereby incorporated by reference in its entirety.

In this step, a controlled amount of adsorbent particles is mixed with the degummed triglycerides. An effective amount of adsorbent particles is used in order to reduce the amount of phosphorus in the degummed triglycerides to a desired level (e.g., typically, greater than 1 ppm to about 10 ppm). The effective amount of adsorbent particles necessary to reduce the amount of phosphorus in the degummed triglycerides to a desired level differs depending on the type of adsorbent particles used, and the starting degummed triglycerides. In one desired embodiment of the present invention, an effective amount of TriSyl® silica hydrogel particles commercially available from W.R. Grace (Columbia, Md.) is used. See, for example, European Patent Applications EP 0185 182 A1 and EP 05707 424 A1, which disclose the use of an effective amount of TriSyl® silica hydrogel particles to reduce the amount of phosphorus in degummed triglycerides in the preparation of edible oils, the subject matter of each of which is hereby incorporated by reference in its entirety. It has been discovered that a smaller concentration of TriSyl® silica hydrogel particles (e.g., the ratio of the mass of silica particles to the mass or volume of degummed triglycerides) is needed to reduce the amount of phosphorus in the degummed triglycerides to a desired level due to the superior adsorption properties of TriSyl® silica hydrogel particles.

Typically, degummed triglycerides are mixed with adsorbent particles under atmospheric pressure for a time period ranging from about 15 minutes to about 45 minutes in order to effectively remove phospholipids and trace metals from the degummed triglycerides. In some embodiments, effective removal of phosphorus from the degummed triglycerides using adsorbent particles takes place within a time period ranging from about 15 minutes to about 20 minutes (e.g., total mixing time from initial contact until the beginning of a drying step).

Prior to being brought into contact with the adsorbent particles, the degummed triglycerides may be preheated to a desired temperature. Alternatively, the triglycerides may be heated after contact with the adsorbent. Any conventional heat exchanger or jacketed vessel may be used to preheat the degummed triglycerides. In one exemplary embodiment, the degummed triglycerides are preheated to a desired temperature ranging from about 60° C. to about 90° C., desirably from about 70° C. to about 80° C.

Following the mixing step, the triglyceride/adsorbent particle mixture is typically dried to reduce the amount of moisture in the mixture to a maximum level of about 0.20 wt % based on a total weight of the triglyceride/adsorbent particle mixture, and typically to a maximum of about 0.10 wt %

Once the triglyceride/adsorbent particle mixture is dried and the amount of phosphorus in the degummed triglycerides is reduced to a desired level as mentioned herein, the triglycerides/adsorbent particle mixture is further processed through a filtration step.

3. Filtration Step

In the methods of the present invention, the dried triglycerides/adsorbent particle mixture then proceeds to a filtration device in order to separate the triglycerides and the adsorbent particles. Any type of standard/existing filter such as pressure leaf filters, plate & frame filter, candle filter and/or membrane filter can be used in this step.

Once separated, the adsorbent particles may be disposed of using conventional disposal techniques. The resulting adsorbent-treated triglyceride product is further processed as described below.

4. Stripping Step

In the methods of the present invention, the adsorbent-treated triglyceride product is subjected to a stripping step, wherein the amount of free fatty acids within the adsorbent-treated triglyceride product is reduced to a desired level. Typically, the stripping step reduces the amount of free fatty acids within the adsorbent-treated triglyceride product to less than about 0.30 wt %, based on a total weight of the adsorbent-treated triglyceride product. Desirably, the stripping step reduces the amount of free fatty acids within the adsorbent-treated triglyceride product to an amount ranging from greater than 0.05 wt % to about 0.20 wt %, more desirably, from greater than about 0.06 wt % (or about 0.07 wt %, or about 0.08 wt %, or about 0.09 wt %) to about 0.20 wt % (or about 0.19 wt %, or about 0.18 wt %, or about 0.17 wt %, or about 0.16 wt %, or about 0.15 wt %, or about 0.14 wt %, or about 0.13 wt %, or about 0.12 wt %, or about 0.11 wt %, or about 0.10 wt %), based on a total weight of the adsorbent-treated triglyceride product.

One advantage of the stripping step lies in the reduction of costs and production time as compared to a deodorizing process. A deodorizing process or step as defined herein and as accepted in the industry, typically involves the removal of free fatty acids, odor, flavor and destabilizing impurities, as well as color bodies by subjecting the oil to high vacuum and temperature using steam agitation under conditions so that the impurities are vaporized and removed while the oil remains liquid. Deodorizing processes are described in U.S. Pat. Nos. 4,613,410; 4,588,745; 4,599,143; 4,601,790; 4,609,500; 4,804,555; 4,971,660; 4,996,072; 5,948,209; 6,172,248; and 6,953,499, the subject matter of which is incorporated herein by reference. A stripping process, as defined herein and as accepted in the industry, involves the removal of free fatty acids from oil under the conditions set forth herein.

In one exemplary embodiment, the adsorbent-treated triglyceride product is introduced into a packed column in order to strip free fatty acids from the adsorbent-treated triglyceride product using a stripping medium. Typically, the adsorbent-treated triglyceride product and the stripping medium are introduced into a packed column using a counter-flow technique. For example, the adsorbent-treated triglyceride product may be introduced into an upper portion (e.g., a top) of a packed column and removed from a lower portion (e.g., a bottom) of the packed column, while the stripping medium is introduced into a lower portion (e.g., the bottom) of the packed column and removed from an upper portion (e.g., the top) of the packed column (along with free fatty acids stripped from the adsorbent-treated triglyceride product).

The packed column may be any conventional packed column known in the art. The packed column has dimensions that enable a desired flow rate of adsorbent-treated triglyceride product and stripping medium through the packed column. It is to be understood that packed columns having any length, cross-sectional area, and/or cross-sectional configuration may be used in the present invention as long as the packed column is capable of reducing the amount of free fatty acids in the adsorbent-treated triglyceride product to a desired level within a desired amount of time.

Typically, the packed column is packed with a packing material so as to increase a reactive surface area within a reactive zone of the packed column. Any packing material known in the art may be used in this exemplary embodiment of the present invention.

The stripping medium may be any medium capable of removing free fatty acids from the adsorbent-treated triglyceride product. Suitable stripping medium include, but are not limited to, solvent, gases, steam, etc. In one exemplary embodiment, the stripping medium comprises steam.

In one desired embodiment, the packed column is equipped with a vacuum system that enables the stripping step to take place at a system pressure below atmospheric pressure. For example, the system pressure of the packed column may range from about 1 mbar to about 30 mbar, typically, from about 1 mbar to about 20 mbar, and more typically, from about 1 mbar to about 10 mbar, and even more typically, from about 1 to about 5 mbar. In one exemplary embodiment, the packed column using steam having a temperature of about 260° C. as the stripping medium, and has a system pressure of about 3 mbars.

Prior to being brought into contact with the stripping medium, the adsorbent-treated triglyceride product may be preheated to a desired temperature using any conventional heat exchanger or jacketed vessel. In one exemplary embodiment, the adsorbent-treated triglyceride product is preheated to a desired temperature ranging from about 240° C. to about 280° C., desirably from about 240° C. to about 260° C.

In this step, a controlled amount of stripping medium is mixed with the adsorbent-treated triglyceride product. Flow rates of both the stripping medium and the adsorbent-treated triglyceride product may be adjusted in order to effectively reduce the amount of free fatty acids in the adsorbent-treated triglyceride product to a desired level (e.g., typically, from about 0.01 wt % to about 0.04 wt %).

Typically, flow rates of both the stripping medium and the adsorbent-treated triglyceride product may be adjusted in order to effectively reduce the amount of free fatty acids in the adsorbent-treated triglyceride product to less than about 0.30 wt % (e.g., typically, from about 0.04 wt % to about 0.25 wt % and more typically from about 0.5 wt % to about 0.20 wt %) (based on a total weight of the adsorbent-treated triglyceride product) in less than about 60 minutes (e.g., an average amount, e.g., a milliliter, of adsorbent-treated triglyceride product is in contact with the stripping medium for a time period of less than about 60 minutes) (or less than about 50 minutes or less than about 40 minutes, or less than about 30 minutes, or less than about 20 minutes, or less than about 10 minutes, or less than 5 minutes, or less than 4 minutes, or less than 3 minutes or less than 2 minutes, or less than 1 minute). In another exemplary embodiment, flow rates of both the stripping medium and the adsorbent-treated triglyceride product may be adjusted in order to effectively reduce the amount of free fatty acids in the adsorbent-treated triglyceride product to less than about 0.30% wt % (e.g., typically, from about 0.04 wt % to about 0.25% wt %, more typically from about 0.04 wt % to about 0.20 wt %) (based on a total weight of the adsorbent-treated triglyceride product) in less than about 1 minute (e.g., an average amount, e.g., a milliliter, of adsorbent-treated triglyceride product is in contact with the stripping medium for a time period of less than about 1 minute).

In embodiments using a packed column, the contact time between adsorbent-treated triglyceride product and stripping medium may be determined by the residence time of adsorbent-treated triglyceride product within the column. For a packed column having a first end and a second end opposite the first end, with the adsorbent-treated triglyceride product being introduced into the first end and exiting the second end, and the stripping medium being introduced into the second end and exiting the first end, the amount of free fatty acids in the adsorbent-treated triglyceride product may be reduced to an amount of less than about 0.30 wt % (e.g., typically, from about 0.04 wt % to about 0.25% wt %, more typically from about 0.04 wt % to about 0.20 wt %) (based on a total weight of the adsorbent-treated triglyceride product) in less than about 60 minutes (e.g., an average amount of adsorbent-treated triglyceride product is in and through the column in less than about 60 minutes) (or less than about 50 minutes, or less than about 40 minutes, or less than about 30 minutes, or less than about 20 minutes, or less than about 10 minutes, or less than about 5 minutes or less than about 4 minutes, or less than about 3 minutes, or less than about 2 minutes, or less than about 1 minute).

Once the amount of free fatty acids in the adsorbent-treated triglyceride product reaches a desired level, the resulting biodiesel fuel precursor may be stored for future use or further processed to convert the biodiesel fuel precursor to biodiesel fuel as described below.

### II. Methods of Making Biodiesel Fuel

The present invention is also directed to methods of making biodiesel fuel. Such a process may be performed as described in U.S. Pat. Nos. 5,525,126; 5,532,392; 5,578,090; 5,713,965; 5,308,365; 6,015,440; and 6,447,557, the entire subject matter of which is incorporated herein by references.

A. Steps for Making Biodiesel Fuel

The following steps may be used to make biodiesel fuel of the present invention.

1. Transesterification Step

The biodiesel fuel precursor produced using the above-described process steps may be further processed so as to produce a biodiesel fuel. In this embodiment, the biodiesel fuel precursor is subjected to a transesterification step, which converts the biodiesel fuel precursor into smaller ester molecules and glycerin. A typical transesterification step involves a reaction as shown below:

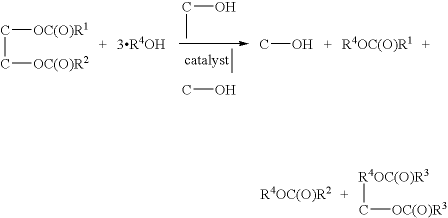

wherein R¹, R² and R³ are each independently an alkyl group having from about 3 to about 22 carbon atoms (more typically from about 12 to about 18 carbon atoms), and R⁴ is an alkyl group having from about 1 to about 4 carbon atoms (more typically from about 1 to about 2 carbon atoms).

As shown in the transesterification reaction above, three moles of lower alkyl esters (i.e., biodiesel fuel) may be produced from one mole of biodiesel fuel precursor. In the above reaction, a catalyst is used to initiate the reaction. Typically, catalysts used in a transesterification reaction are selected from acids and bases. Suitable catalysts include, but are not limited to, NaOH, KOH, and NaOCH₃.

The above reaction suggests that three moles of a lower alkyl alcohol are reacted with a mole of triglyceride. However, it is typically common for more than three moles of lower alkyl alcohol to be used, and more common for about six moles of lower alkyl alcohol to be used per mole of triglyceride in order to push the reaction toward the glycerin/alkyl ester side of the reaction.

Following the transesterification reaction, glycerin is separated from the lower alkyl esters using conventional separation techniques.

2. Separation Step

The alkyl esters produced using the above-described process steps are separated from the glycerin and any other reaction by-products and/or reactants using conventional separation techniques. Typically, the alkyl esters are separated from the glycerin via conventional separation techniques including, but not limited to, standing, centrifugation, membrane separation, molecular distillation and superfractionation.

### Washing/Cleaning

Subsequently, alkyl esters are cleaned or purified to remove by-products or impurities (e.g., soaps) so as to prepare a biodiesel fuel precursor that is suitable for making biodiesel fuel (e.g., that conforms with ASTM D 6751 and DIN EN 14214). The resulting alkyl esters may be used as a biodiesel fuel in combustion engines.

B. Exemplary Method for Making Biodiesel Fuel

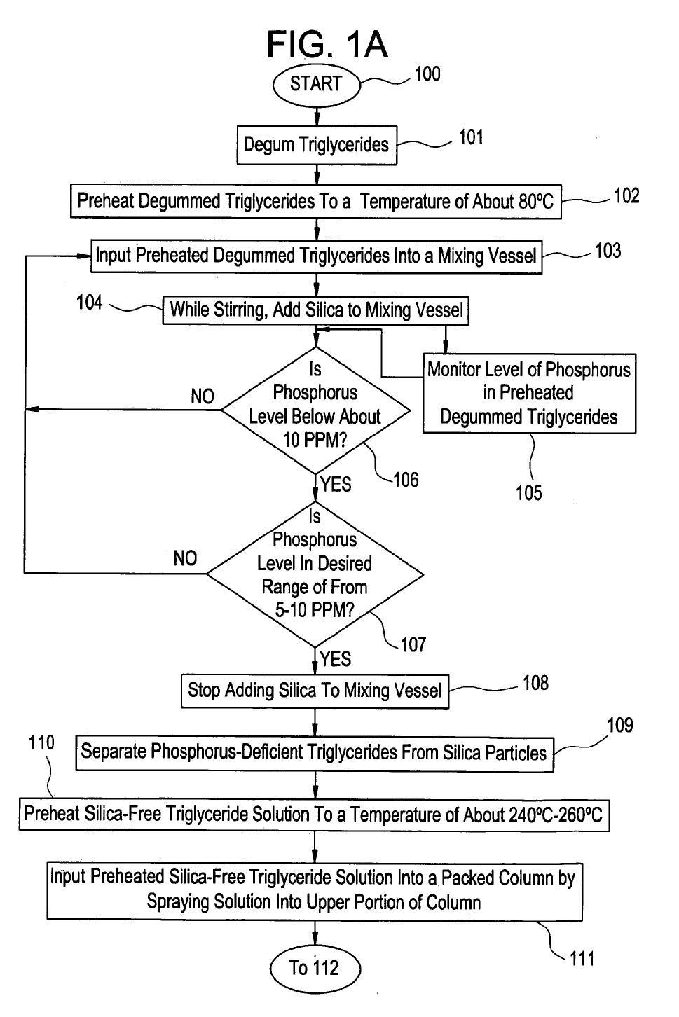

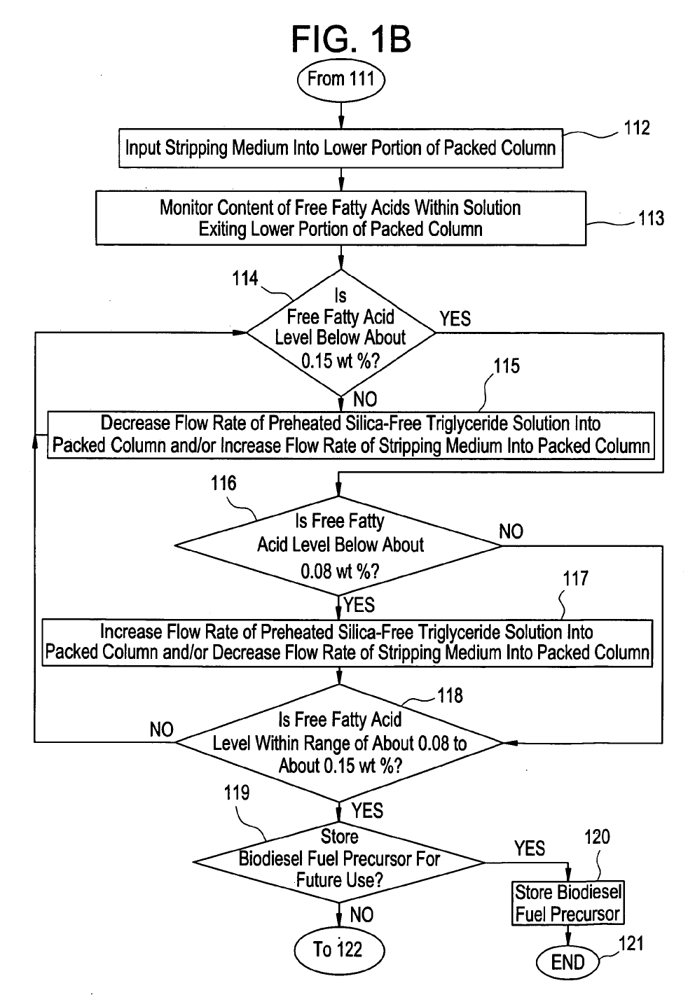

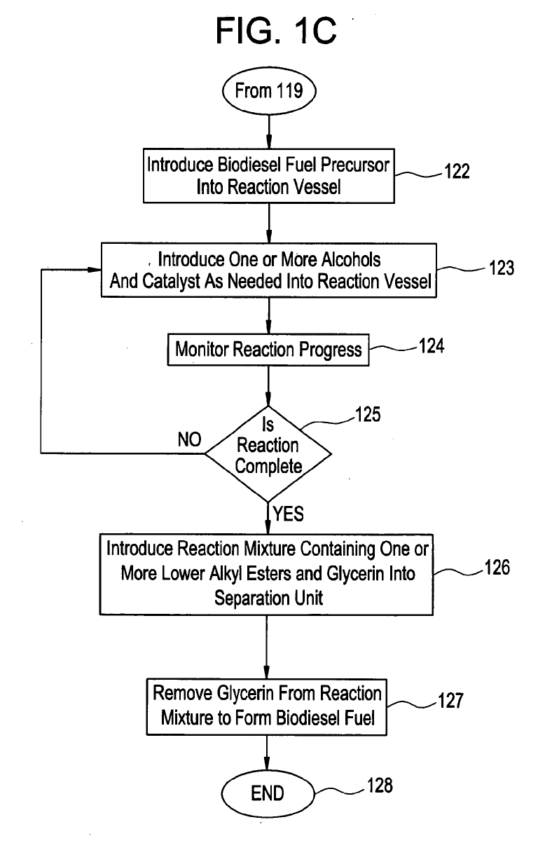

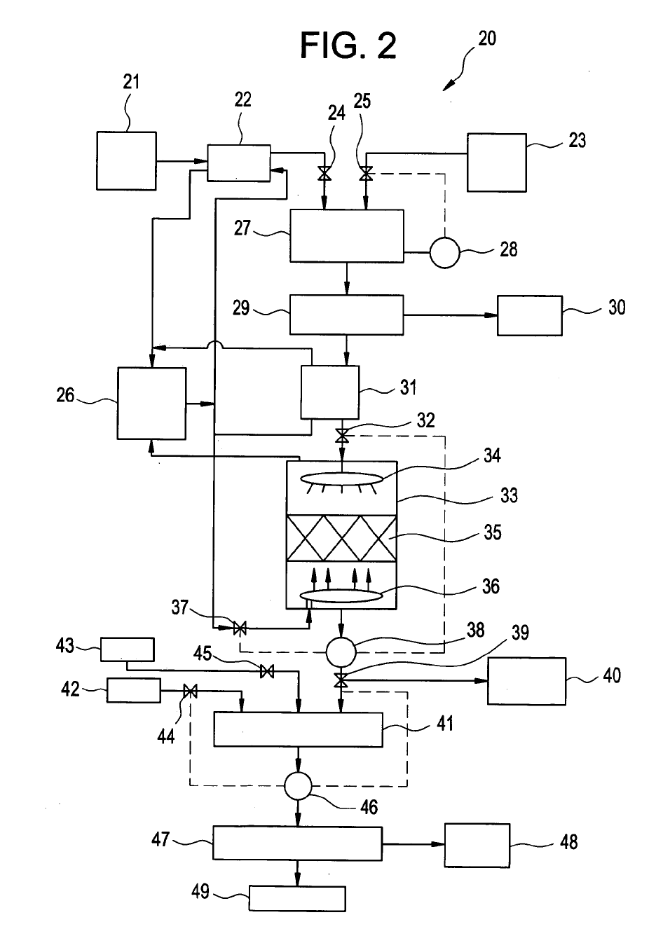

One exemplary method of making biodiesel fuel according to the present invention is depicted in FIGS. 1A-1C. As shown in FIG. 1A, exemplary method 10 starts at block 100, and proceed to step 101, wherein crude triglycerides are subjected to a conventional degumming process such as any of the above-described degumming processes. As discussed above, the phosphorus content of the crude triglycerides is reduced to a level of below about 50 ppm in a typical degumming process such as those mentioned above. From step 101, exemplary method 10 proceeds to step 102, wherein the degummed triglycerides are preheated to a temperature of about 70 to about 90° C. using the packed column or a conventional heat exchanger. For example, steam or some other heated fluid (e.g., heated water, the steam leaving heat exchanger 31 shown in FIG. 2, or the steam/free fatty acid mixture leaving packed column 33 shown in FIG. 2) may be used to heat the degummed triglycerides using a heat exchanger. From step 102, exemplary method 10 proceeds to step 103, wherein the preheated degummed triglycerides are added to a mixing vessel. From step 103, exemplary method 10 proceeds to step 104, wherein adsorbent is added to the mixing vessel containing the preheated degummed triglycerides. From step 104, exemplary method 10 proceeds to step 105, wherein the amount of phosphorus in the preheated degummed triglycerides is monitored using conventional process control equipment.

Once the amount of phosphorus in the preheated degummed triglycerides is determined in step 105, exemplary method 10 proceeds to decision block 106. At decision block 106, a determination is made by process control equipment whether the amount of phosphorus in the preheated degummed triglycerides is below about 10 ppm, typically below about 5 ppm. If a determination is made at decision block 106 that the amount of phosphorus in the preheated degummed triglycerides is not below about 10 ppm, more typically below about 5 ppm, exemplary method 10 returns to step 104 and proceeds as described above. If at decision block 106 a determination is made that the amount of phosphorus in the preheated degummed triglycerides is below about 10 ppm, exemplary method 10 proceeds to decision block 107.

At decision block 107, a determination is made by process control equipment whether the amount of phosphorus in the preheated degummed triglycerides is within a desired range of from about 5 ppm to about 10 ppm. If a determination is made at decision block 107 that the amount of phosphorus in the preheated degummed triglycerides is not within a desired range of from about 5 ppm to about 10 ppm, exemplary method 10 returns to step 104 and proceeds as described above. If at decision block 107 a determination is made that the amount of phosphorus in the preheated degummed triglycerides is within a desired range of from about 5 ppm to about 10 ppm, exemplary method 10 proceeds to step 108.

In step 108 of exemplary method 10, the addition of adsorbent to the mixing vessel is stopped. From step 108, exemplary method 10 proceeds to step 109, wherein phospholipids-deficient triglycerides are separated from adsorbent particles using a filtration step as described above resulting in a adsorbent-free triglyceride product. From step 109, exemplary method 10 proceeds to step 110, wherein the adsorbent-free triglyceride product is preheated to a desired temperature ranging from about 240° C. to about 260° C. From step 110, exemplary method 10 proceeds to step 111, wherein the preheated adsorbent-free triglyceride product is introduced into a packed column. As discussed above, it is desirable for the preheated adsorbent-free triglyceride product to be introduced into an upper portion or the top of the packed column and exit a lower portion or bottom of the packed column. In one desired embodiment, the preheated adsorbent-free triglyceride product enters into an upper portion of the packed column and is sprayed downward onto packing material within the packed column (see, for example, FIG. 2, exemplary apparatus 20 comprising spray assembly 34 within packed column 33).

From step 111, exemplary method 10 proceeds to step 112 shown in FIG. 1B, wherein a stripping medium is introduced into the packed column. As discussed above, it is desirable for the stripping medium to be introduced into a lower portion or the bottom of the packed column and exit an upper portion or top of the packed column (along with free fatty acids stripped from the preheated adsorbent-free triglyceride product). In one desired embodiment, the stripping medium enters into a lower portion of the packed column and is distributed uniformly across the cross-sectional configuration of the packed column so as to move upward toward packing material within the packed column (see, for example, FIG. 2, exemplary apparatus 20 comprising stripping medium distribution assembly 36 within packed column 33).

From step 112, exemplary method 10 proceeds to step 113, wherein the amount of free fatty acids within the preheated adsorbent-free triglyceride product exiting the packed column is monitored using conventional process control equipment. Once the amount of free fatty acids within the preheated adsorbent-free triglyceride product exiting the packed column is determined in step 113, exemplary method 10 proceeds to decision block 114, wherein a determination is made by process control equipment whether the amount of free fatty acids within the preheated adsorbent-free triglyceride product exiting the packed column is below about 0.20 wt % based on a total weight of the product exiting the packed column. If a determination is made at decision block 114 that the amount of free fatty acids within the preheated adsorbent-free triglyceride product exiting the packed column is not below about 0.20 wt %, exemplary method 10 proceeds to step 115, wherein the flow rate of the preheated adsorbent-free triglyceride product entering the packed column is decreased and/or the flow rate of the stripping medium entering the packed column is increased. From step 115, exemplary method 10 returns to decision block 114 and proceeds as described above.

If at decision block 114 a determination is made that the amount of free fatty acids within the preheated adsorbent-free triglyceride product exiting the packed column is below about 0.20 wt % based on a total weight of the product exiting the packed column, exemplary method 10 proceeds to decision block 116, wherein a determination is made by process control equipment whether the amount of free fatty acids within the preheated adsorbent-free triglyceride product exiting the packed column is below about 0.08 wt % based on a total weight of the product exiting the packed column. If a determination is made at decision block 116 that the amount of free fatty acids within the preheated adsorbent-free triglyceride product exiting the packed column is below about 0.08 wt %, exemplary method 10 proceeds to step 117, wherein the flow rate of the preheated adsorbent-free triglyceride product entering the packed column is increased and/or the flow rate of the stripping medium entering the packed column is decreased. From step 117, exemplary method 10 proceeds to decision block 118. If a determination is made at decision block 116 that the amount of free fatty acids within the preheated adsorbent-free triglyceride product exiting the packed column is not below about 0.08 wt %, exemplary method 10 proceeds directly to decision block 118.

At decision block 118 a determination is made by process control equipment whether the amount of free fatty acids within the preheated adsorbent-free triglyceride product exiting the packed column is within a desired range of from about 0.08 to about 0.20 wt % based on a total weight of the product exiting the packed column. If a determination is made at decision block 118 that the amount of free fatty acids within the preheated adsorbent-free triglyceride product exiting the packed column is not within a desired range of from about 0.08 to about 0.20 wt %, exemplary method 10 returns to decision block 114 and proceeds as described above. If a determination is made at decision block 118 that the amount of free fatty acids within the preheated adsorbent-free triglyceride product exiting the packed column is within a desired range of from about 0.08 to about 0.20 wt %, a biodiesel fuel precursor is prepared and exemplary method 10 proceeds to decision block 119.

At decision block 119 a determination is made by an equipment operator whether the resulting biodiesel fuel precursor is to be stored for future use. If a determination is made at decision block 119 that the biodiesel fuel precursor is to be stored for future use, exemplary method 10 proceeds to step 120, wherein biodiesel fuel precursor is stored for future use. The biodiesel fuel precursor may be stored in any container suitable for storing biodiesel fuel precursor (e.g., a stainless steel or plastic vessel). From step 120, exemplary method 10 proceeds to end block 121, where exemplary method 10 ends.

Returning to decision block 119, if a determination is made that the biodiesel fuel precursor is not to be stored for future use, exemplary method 10 proceeds to step 122 (shown in FIG. 1C), wherein biodiesel fuel precursor is introduced into a reaction vessel. From step 122, exemplary method 10 proceeds to step 123, wherein one or more lower alkyl alcohols (e.g., methanol, ethanol, or a combination thereof) and a catalyst are introduced into the reaction vessel. From step 123, exemplary method 10 proceeds to step 124, wherein the progress of the reaction between the biodiesel fuel precursor and the one or more lower alkyl alcohols is monitored using conventional process control equipment. For example, process control equipment may be used to monitor the concentration of one or more of the reactants and/or one or more products of the reaction.

Once the progress of the reaction is determined in step 124, exemplary method 10 proceeds to decision block 125, wherein a determination is made by process control equipment whether the reaction is completed to a desired degree (e.g., up to complete conversion of the biodiesel fuel precursor to one or more lower alkyl esters). If a determination is made at decision block 125 that the reaction has not proceeded to a desired degree, exemplary method 10 returns to step 123 and proceeds as described above. If a determination is made at decision block 125 that the reaction has proceeded to a desired degree, exemplary method 10 proceeds to step 126, wherein the reaction mixture containing one or more lower alkyl esters and glycerin (and any unreacted reactants) are introduced to a separation unit. From step 126, exemplary method 10 proceeds to step 127, wherein the one or more lower alkyl esters are separated from the glycerin (and any unreacted reactants) to form a biodiesel fuel.

The resulting biodiesel fuel may be stored in any container suitable for storing biodiesel fuel (e.g., a stainless steel or plastic vessel) and should conform to ASTM D 7651 and/or DIN EN 14214. From step 127, exemplary method 10 proceeds to end block 128, where exemplary method 10 ends.

As shown in exemplary method 10, biodiesel fuel precursor and biodiesel fuel of the present invention may be made in a continuous process as described above. However, it should be understood that one or more of the above-described method steps in exemplary method 10 could be performed in a batch process step although a continuous process is desired. Regardless of whether the method is a batch or continuous process, it should be noted that the disclosed method of making biodiesel fuel precursor or biodiesel fuel does not comprise or require any washing steps or a deodorizing step. Consequently, the disclosed method of making biodiesel fuel precursor or biodiesel fuel generates a minimum amount of water effluent, does not require expensive equipment needed for a deodorizing step, and does not require the dwell times needed in other processes, such as processes used in the edible oil production (e.g., the dwell times needed in order to deodorize an edible oil).

Although a vacuum system is not shown in FIG. 1, exemplary apparatus 20 could further comprise a vacuum system as described above. Typically, one or more process steps of the disclosed method of making biodiesel fuel precursor and/or biodiesel fuel are conducted under a vacuum. For example, a vacuum system may be used to dry the adsorbent particle/triglyceride mixture prior to the above-described filtration step using a system pressure of about 50 mbars, while a vacuum system may be used to with a packed column in order to produce a very high negative pressure, typically about 3 mbars while removing free fatty acids from the adsorbent-free triglyceride product.

### III. Apparatus for Making Biodiesel Fuel Precursors and Biodiesel Fuel

The present invention is even further directed to an apparatus capable of being used to make a biodiesel fuel precursor and biodiesel fuel. In one exemplary embodiment, the apparatus for producing the biodiesel fuel precursor comprises a mixing vessel suitable for bringing degummed triglycerides into contact with a plurality of adsorbent particles; a drying vessel in-line with the mixing vessel; a filtration device in-line with the drying vessel, wherein the filtration device is suitable for separating phospholipids-deficient triglycerides from the plurality of adsorbent particles; and a packed column in-line with the filtration device, wherein the packed column is suitable for counter-flow mass transfer between a adsorbent-treated triglyceride product and a stripping medium. In order to convert the biodiesel fuel precursor to biodiesel fuel, the apparatus may also include a reaction vessel in-line with a storage tank of biodiesel fuel precursor, wherein the reaction vessel is suitable for reacting a biodiesel fuel precursor with a one or more lower alkyl alcohols; and a separation unit in-line with the reaction vessel, wherein the separation unit is suitable for removing glycerin (and any unreacted reactants or by-product) from the fatty acid alkyl esters so as to form a biodiesel fuel.

As shown in FIG. 2, exemplary apparatus 20 comprises the following components: degummed triglycerides storage container 21; first heat exchanger 22; adsorbent particle storage container 23; one-way valves 24 and 25 for controlling the flow rate of degummed triglycerides and adsorbent particles respectively into mixing vessel 27; first process control unit 28 for monitoring the amount of phosphorus in the degummed triglycerides within mixing vessel 27 and providing feedback to one-way valve 25; filtration unit 29; adsorbent waste storage unit 30; second heat exchanger 31; one-way valve 32 for controlling the flow rate of preheated adsorbent-treated triglyceride product into packed column 33; one-way valve 37 for controlling the flow rate of stripping medium (e.g., steam) into packed column 33; second process control unit 38 for monitoring the amount of free fatty acids in the adsorbent-treated triglyceride product exiting packed column 33 and providing feedback to one-way valves 32 and 37; one-way T-valve 39 for controlling the flow rate of biodiesel fuel precursor into either reaction vessel 41 or biodiesel fuel precursor storage container 40; alcohol storage container 42; catalyst storage container 43; one-way valves 44 and 45 for controlling the flow rate of alcohol and catalyst respectively into reaction vessel 41; third process control unit 46 for monitoring the progress of the reaction within reaction vessel 41 and providing feedback to one-way valves 39 and 44 (and optionally one-way valve 45); separation unit 47 for separating biodiesel fuel from glycerin and any unreacted reactants; glycerin reclamation and/or waste container 48; and biodiesel fuel storage container 49.

Steam generation unit 26 may be used to supply steam to first heat exchanger 22, second heat exchanger 31, and packed column 33. In some embodiments, steam generation unit 26 is used to supply steam to second heat exchanger 31 and packed column 33, while another heated fluid (e.g., steam exiting second heat exchanger 31 or biodiesel fuel precursor exiting packed column 33) is used in first heat exchanger 22 to preheat the degummed triglycerides. Further, although not shown in FIG. 2, steam exiting packed column 33 may be further processed in order to separate the steam from the free fatty acids therein.

As shown in FIG. 2, packed column 33 desirably comprises spray assembly 34 in an upper portion of packed column 33 for spraying adsorbent-treated triglyceride product over packing material 35 within a central region of packed column 33 and stripping medium distribution assembly 36 in a lower portion of packed column 33 for uniformly distributing stripping medium (e.g., steam) across a cross-sectional configuration of packed column 33 so as to move upward toward packing material 35 within packed column 33.

### IV. Biodiesel Fuel Precursors and Biodiesel Fuel

The present invention is even further directed to biodiesel fuel precursor formed by the methods of the present invention. The biodiesel fuel precursor may be efficiently produced without concerns such as product color, a product deodorizing step (i.e., to remove any unwanted odor from the product), and any process water effluent. The biodiesel fuel produced by the methods of the present invention may be utilizing in combustion engines as a substitute for conventional fuels such as diesel fuel.

While the invention has been described with a limited number of embodiments, these specific embodiments are not intended to limit the scope of the invention as otherwise described and claimed herein. It may be evident to those of ordinary skill in the art upon review of the exemplary embodiments herein that further modifications and variations are possible. All parts and percentages in the examples, as well as in the remainder of the specification, are by weight unless otherwise specified. Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, R_{L}, and an upper limit R_{U}, is disclosed, any number R falling within the range is specifically disclosed. In particular, the following numbers R within the range are specifically disclosed: R=R_{L}+k(R_{U}−R_{L}), where k is a variable ranging from 1% to 100% with a 1% increment, e.g., k is 1%, 2%, 3%, 4%, 5%. . . . 50%, 51%, 52% . . . 95%, 96%, 97%, 98%, 99%, or 100%. Moreover, any numerical range represented by any two values of R, as calculated above is also specifically disclosed. Any modifications of the invention, in addition to those shown and described herein, will become apparent to those skilled in the art from the foregoing description and accompanying drawings. Such modifications are intended to fall within the scope of the appended claims.

### Illustrative Examples

The following Examples are given as specific illustrations of the claimed invention. It should be understood, however, that the invention is not limited to the specific details set forth in the Examples.

### Example 1

### Treatment of Degummed Triglyceride with Silica Gel

100 g oil is weighed into a double necked round flask, which is then immersed to about ⅓ of its height in a silicone oil bath held at 90° C.-100° C. and the contents all mixed using a magnetic stirrer. The temperature of the oil bath is controlled with a contact thermometer. After the oil in the flask has reached 70° C. (measured with a Vario thermometer), silica gel (Trisyl® silica available from W. R. Grace & Co.-Conn.) is added and mixed for 15 minutes while maintaining the temperature at 70° C. The round flask is then fully immersed in the silicone oil bath and the contents heated to 95° C. under vacuum using a water pump. After the temperature reaches 90° C.-95° C., the contents are stirred for further 10 minutes at maximum mixing speed while maintaining the temperature. The flask is then removed from the oil bath and the contents are allowed to cool to 80° C. The vacuum is stopped and the silica gel is filtered from the oil using a Buchner filter. The resulting sample is measured for phosphorous and trace elements (e.g., Ca, Mg and Fe) are measured using an ICP spectrophotometer.

Phosphorus and Trace Element Levels (PPM) in Acid Degummed Rapeseed Oil Before and after Silica Treatment

| | P | Mg | Fe | Ca |
|---|---|---|---|---|
| Starting Oil | 23.7 | 5.9 | 0.67 | 22.4 |
| Treated Oil | 2.4 | 0.7 | 0.05 | 2.5 |

Phosphorus and Trace Element Levels (PPM) in Acid Degummed Soybean Oil Before and after Silica Treatment

| | P | Mg | Ca |
|---|---|---|---|
| Starting Oil | 12.0 | 1.2 | 1.8 |
| Treated Oil | 1.0 | 0.2 | 0.1 |

Phosphorus and Trace Element Levels (PPM) in Enzymatic Degummed Rapeseed Oil Before and after Silica Treatment

| | P | Mg | Fe | Ca | FFA % |
|---|---|---|---|---|---|
| Starting oil | 11.2 | 2.0 | 0.08 | 6.02 | 1.36 |
| Treated oil | 0.6 | 0.1 | 0.04 | 0.27 | 1.27 |

Phosphorus and Trace Element Levels (PPM) in Enzymatic Degummed Soybean Oil Before and after Silica Treatment

| | P | Mg | Fe | Ca | FFA % |
|---|---|---|---|---|---|
| Starting Oil | 8.6 | 0.56 | 0.10 | 0.79 | 0.61 |
| Treated oil | 0.9 | 0.1 | 0.05 | 0.15 | 0.59 |

### Example 2

### Removal of Free Fatty Acid from Triglycerides Using Stripping Process

The main objective of the stripping process is the reduction of the free fatty acid content of the oil as far as possible (e.g., less than 0.20 wt. %). Colour removal is not necessary.

The stripping process is the final stage in the physical refining of triglycerides during the production of the biodiesel fuel precursor according to the invention. During the stripping (evaporation or de-acidification by distillation) step, a wide range of unwanted fatty acids are removed. These substances have a higher vapour pressure than the triglycerides and can therefore be separated by distillation at high temperature (e.g., 240-260° C.) and low pressure (e.g., 3-6 mm Hg), generally using steam as a carrier in a relatively short time (less than 5 minutes).

A cylindrical trap is filled with liquid nitrogen and covered (the level of the liquid nitrogen should be checked occasionally). A 250 ml round bottom flask is filled with about 100 g of triglyceride treated as in Example 1. The steam delivery tube and thermometer tube should be well covered with oil. Water (2-4% of the weight of the oil) is added to a 250 ml steam reservoir flask. Nitrogen is passed through a bleed pipe to cause a good stirring of the oil. The oil is heated to 220° C. under constant nitrogen blanket. When the temperature of the oil reaches 250° C., the nitrogen flow is discontinued and the sample is stripped under a pressure of about 3 mm Hg for a period of 5 minutes. The oil sample is cooled to about 120° C. The nitrogen flow is resumed and the vacuum pump switched off. Water bath is placed under the oil sample and allowed to cool to room temperature. The oil sample is transferred under nitrogen to a screw cap bottle and kept in the dark in a refrigerator.

The sample is then tested for its content of free fatty acids as in Example 1.

Free fatty acid levels (wt. %) in Rapeseed oil

| | FFA wt./% |
|---|---|
| Acid degummed Oil | 0.72 |
| TriSyl treated | 0.65 |
| After stripping | 0.14 |

The examples demonstrate that present inventive process and apparatus yields an economically viable biodiesel precursor that is suitable for biodiesel production.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A method of forming a biodiesel fuel precursor, said method comprising the steps of:
bringing degummed triglycerides into contact with a plurality of adsorbent particles to reduce an amount of phosphorus within said degummed triglycerides so as to form phospholipids-deficient triglycerides;
separating said phospholipids-deficient triglycerides from said plurality of adsorbent particles to form a adsorbent-treated triglyceride product; and
contacting said adsorbent-treated triglyceride product with a stripping medium to reduce an amount of free fatty acids within said adsorbent-treated triglyceride product so as to form a biodiesel fuel precursor; wherein said method does not comprise a deodorizing step.

2. The method of claim 1, further comprising reacting said biodiesel fuel precursor with one or more alcohols to form alkyl esters in combination with glycerin; and
removing said glycerin from said alkyl esters to form a biodiesel fuel.

3. The method of claim 1, further comprising a drying step after said bringing step and before said separating step.

4. The method of claim 1, wherein said bringing step reduces an amount of phosphorus within said degummed triglycerides to an amount ranging from about 2 ppm to about 10 ppm.

5. The method of claim 1, wherein said contacting step reduces an amount of free fatty acids within said adsorbent-treated triglyceride product to an amount ranging from about 0.04% to about 0.20 wt % based on a total weight of adsorbent-treated triglyceride product.

6. The method of claim 1, wherein in said contacting step, an average amount of adsorbent-treated triglyceride product is in contact with said stripping medium for a time period of less than about 60 minutes.

7. The method of claim 1, wherein in said contacting step, an average amount of adsorbent-free triglyceride product is in contact with said stripping medium for a time period of less than about 30 minutes.

8. The method of claim 1, wherein in said contacting step, an average amount of adsorbent-free triglyceride product is in contact with said stripping medium for a time period of less than about 20 minutes.

9. The method of claim 1, wherein in said contacting step, an average amount of adsorbent-free triglyceride product is in contact with said stripping medium for a time period of less than about 10 minutes.

10. The method of claim 1, wherein said contacting step is conducted within a column having a first end and a second end opposite the first end, said adsorbent-treated triglyceride product is introduced into said first end and exits said second end, said stripping medium is introduced into said second end and exits said first end, and wherein an average amount of adsorbent-free triglyceride product is in said column for a time period of less than about 60 minutes.

11. The method of claim 1, wherein said biodiesel fuel precursor has a color and a triglyceride odor.

12. A biodiesel fuel precursor formed by the method of any one of claims 1 to 11.

13. A biodiesel fuel formed by the method of claims 1-8.

14. The method of any one of claims 1 to 8, further comprising the step of:
utilizing said biodiesel fuel in a combustion engine.

15. A method of forming a biodiesel fuel precursor, said method comprising the steps of:
bringing degummed triglycerides into contact with a plurality of adsorbent particles to reduce an amount of phosphorus within said degummed triglycerides so as to form phospholipids-deficient triglycerides having from greater than about 1 ppm to about 10 ppm phosphorus;
separating said phospholipids-deficient triglycerides from said plurality of adsorbent particles to form a adsorbent-free triglyceride product; and
contacting said adsorbent-free triglyceride product with a stripping medium to reduce an amount of free fatty acids within said adsorbent-free triglyceride product so as to form a biodiesel fuel precursor, wherein an average amount of adsorbent-treated triglyceride product is in contact with said stripping medium for a time period of less than about 5 minutes.

16. The method of claim 15, wherein said biodiesel fuel precursor has from about 0.04 to about 0.20 wt % free fatty acids based on a total weight of said biodiesel fuel precursor.

17. A biodiesel fuel precursor formed by the method of any one of claims 15 to 16.

18. The method of claim 15, further comprising the step of:
reacting said biodiesel fuel precursor with one or more alcohols to form alkyl esters in combination with glycerin; and
removing said glycerin from said alkyl esters to form a biodiesel fuel.

19. An apparatus for performing the method of any one of claims 1 to 11, 15, 16 and 18.

20. An apparatus capable of forming a biodiesel fuel precursor, said apparatus comprising:
a mixing vessel suitable for bringing degummed triglycerides into contact with a plurality of adsorbent particles to reduce an amount of phospholipids within the degummed triglycerides so as to form phospholipids-deficient triglycerides;
a filtration device in-line with said mixing vessel, Drying vessel, said filtration device being suitable for separating the phospholipids-deficient triglycerides from the plurality of adsorbent particles so as to form a adsorbent-free triglyceride product; and
a packed column in-line with said filtration device, said packed column being suitable for contacting the adsorbent-treated triglyceride product with a stripping medium to reduce an amount of free fatty acids within the adsorbent-treated triglyceride product so as to form a biodiesel fuel precursor; wherein said apparatus does not comprise a deodorizer.

21. The apparatus of claim 20 further comprising:
a reaction vessel in-line with said packed column, said reaction vessel being suitable for reacting the biodiesel fuel precursor with one or more alcohols to form alkyl esters in combination with glycerin; and
a separation unit in-line with said reaction vessel, said separation unit being suitable for removing the glycerin from the alkyl esters to form a biodiesel fuel.

22. The apparatus of claim 20, further comprising:
a vacuum dryer or vacuum bleacher in-line with said mixing vessel and said filtration device suitable for drying the phospholipids-deficient triglycerides and adsorbent particles.

23. The apparatus of claim 20, further comprising:
at least one storage container in-line with said packed column, said at least one storage vessel being suitable for storing the biodiesel fuel precursor, the biodiesel fuel, or both.

24. The apparatus of claim 20, further comprising:
a vacuum system in-line with said packed column suitable for providing a system pressure of less than atmospheric pressure within said packed column.

25. The apparatus of claim 23, wherein the system pressure is from about 1 mbar to about 10 mbar.

26. A method of forming a biodiesel fuel precursor, said method comprising the steps of:
bringing degummed triglycerides into contact with a plurality of adsorbent particles to reduce an amount of phosphorus within said degummed triglycerides so as to form phospholipids-deficient triglycerides having from greater than about 2 ppm to about 10 ppm phosphorus; and
converting said phospholipids-deficient triglycerides into a biodiesel fuel precursor.
